(19) United States
(12) Patent Application Publication
(10) Pub. No.: US 2026/0017752 A1
(43) Pub. Date: Jan. 15, 2026

(54) IMAGE PROCESSING SYSTEM, IMAGE PROCESSING APPARATUS, IMAGE PROCESSING METHOD, AND STORAGE MEDIUM

(71) Applicant: Hiroshi Suitoh, KANAGAWA (JP)

(72) Inventor: Hiroshi Suitoh, KANAGAWA (JP)

(73) Assignee: Ricoh Company, Ltd., Tokyo (JP)

(21) Appl. No.: 19/247,326

(22) Filed: Jun. 24, 2025

(30) Foreign Application Priority Data
Jul. 12, 2024 (JP) 2024-112754
Feb. 14, 2025 (JP) 2025-022264

(51) Int. Cl. G06T 3/4038; G06T 3/4007; G06T 7/10

(52) U.S. Cl. CPC G06T 3/4038; G06T 3/4007; G06T 7/10; G06T 2207/20221

(57) ABSTRACT

An image processing system includes processing circuitry. The processing circuitry divides an image to generate a plurality of divided images. The processing circuitry changes pixel values of each of the plurality of divided images. The processing circuitry reduces the image to generate a reduced image of the image. The processing circuitry changes pixel values of the reduced image. The processing circuitry determines a plurality of regions of the reduced image. Each region corresponds to each of the plurality of divided images having the changed pixel values. The processing circuitry corrects the changed pixel values of the divided image based on pixel values of one or more pixels included in the determined region of the reduced image. The processing circuitry combines a plurality of divided images each having the corrected pixel values.

### CROSS-REFERENCE TO RELATED APPLICATIONS

This patent application is based on and claims priority pursuant to 35 U.S.C. § 119 (a) to Japanese Patent Application No. 2024-112754, filed on Jul. 12, 2024, and No. 2025-022264, filed on Feb. 14, 2025, in the Japan Patent Office, the entire disclosure of which is hereby incorporated by reference herein.

### BACKGROUND

### Technical Field

The present disclosure relates to an image processing system, an image processing apparatus, an image processing method, and a storage medium.

### Related Art

A technique is known that pixel values of a low luminance image is changed to pixel values of a high luminance image using generative artificial intelligence (AI). With the technique, even if an image is captured in a scene where the capturing environment is dark, the pixel values of the image can be changed to an image with high luminance to improve visibility.

### SUMMARY

Embodiments of the present disclosure described herein provide a novel image processing system including processing circuitry. The processing circuitry divides an image to generate a plurality of divided images. The processing circuitry changes pixel values of each of the plurality of divided images. The processing circuitry reduces the image to generate a reduced image of the image. The processing circuitry changes pixel values of the reduced image. The processing circuitry determines a plurality of regions of the reduced image. Each region corresponds to each of the plurality of divided images having the changed pixel values. The processing circuitry corrects the changed pixel values of the divided image based on pixel values of one or more pixels included in the determined region of the reduced image. The processing circuitry combines a plurality of divided images each having the corrected pixel values.

Embodiments of the present disclosure described herein provide a novel image processing method executed by a computer. The method includes: dividing an image to generate a plurality of divided images; changing pixel values of each of the plurality of divided images; reducing the image to generate a reduced image of the image; changing pixel values of the reduced image; determining a plurality of regions of the reduced image, each region corresponding to each of the plurality of divided images having the changed pixel values; correcting the changed pixel values of the divided image based on pixel values of one or more pixels included in the determined region of the reduced image; and combining a plurality of divided images each having the corrected pixel values.

Embodiments of the present disclosure described herein provide a novel non-transitory storage medium storing computer-readable program code that, when executed by a computer, causes the computer to perform an image processing method. The method includes: dividing an image to generate a plurality of divided images; changing pixel values of each of the plurality of divided images; reducing the image to generate a reduced image of the image; changing pixel values of the reduced image; determining a plurality of regions of the reduced image, each region corresponding to each of the plurality of divided images having the changed pixel values; correcting the changed pixel values of the divided image based on pixel values of one or more pixels included in the determined region of the reduced image; and combining a plurality of divided images each having the corrected pixel values.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a system configuration of an image generation system;

FIG. 2 is a diagram illustrating a hardware configuration of an image processing system;

FIG. 3 is a diagram illustrating a functional configuration of an image processing unit of an image processing system;

FIG. 4 is a diagram illustrating processing executed by a divided image generation unit of an image processing unit;

FIG. 5 is a diagram illustrating processing executed by a first changing unit of an image processing unit;

FIG. 6 is a diagram illustrating processing executed by a reduced image generation unit of an image processing unit;

FIG. 7 is a diagram illustrating processing executed by a second changing unit of an image processing unit;

FIG. 8 is a first diagram illustrating processing executed by a corresponding region determination unit and a correction unit of an image processing unit;

FIG. 9 is a second diagram illustrating processing executed by the corresponding region determination unit and the correction unit of the image processing unit of FIG. 8;

FIG. 10 is a third diagram illustrating processing executed by the corresponding region determination unit and the correction unit of the image processing unit of FIG. 8;

FIG. 11 is a fourth diagram illustrating processing executed by the corresponding region determination unit and the correction unit of the image processing unit of FIG. 8;

FIG. 12 is a flowchart of image processing executed by an image processing system;

FIG. 13 is a flowchart of correction processing executed by an image processing system;

FIGS. 14A and 14B are diagrams illustrating images after image processing executed by an image processing system; and

FIGS. 15A and 15B are diagrams illustrating luminance of pixels included in an image after image processing executed by an image processing system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below with reference to the drawings. In this specification and the drawings, components having substantially the same configurations and functions are denoted by the same reference numerals, and redundant description thereof will be omitted.

### First Embodiment

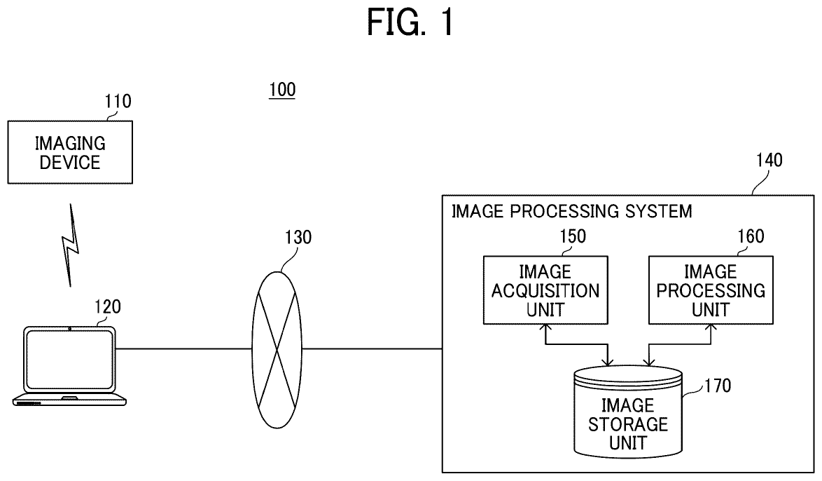

A description is given below of a system configuration of an overall image generation system including an image processing system according to a first embodiment. FIG. 1 is a diagram illustrating the system configuration of the image generation system.

An image generation system 100 is a system that generates an image using an imaging device and performs various processes for adjusting image characteristics on the generated image to generate a highly visible image. The image characteristics refer to characteristics that affect the visibility of an image, such as luminance and color difference. The color difference indicates a color component (i.e., Cb value and Cr value) when the pixel value (i.e., red (R) value, green (G) value, and blue (B) value) of a pixel of an image in the RGB format is converted into a luminance signal (i.e., Y value) and a color difference signal (i.e., Cb value and Cr value).

As illustrated in FIG. 1, the image generation system 100 includes an imaging device 110, an information terminal 120, and an image processing system 140. In the image generation system 100, the information terminal 120 and the image processing system 140 are connected to communicate with each other via a communication network 130.

The imaging device 110 photographs to generate an image and transmits the generated image to the information terminal 120. The imaging device 110 may be of any type, and may be, for example, an omnidirectional camera. The image generated by the imaging device 110 may be expressed in any format, for example, RGB format or YCbCr format. The compression format of the image generated by the imaging device 110 may be any format, and may be, for example, the joint photographic experts group (JPEG) format.

The information terminal 120 transmits the image transmitted from the imaging device 110 to the image processing system 140 via the communication network 130, and instructs the image processing system 140 to execute various processes for adjusting the image characteristics of the image. The information terminal 120 receives and displays an “adjusted image” on which various processes for adjusting image characteristics have been executed from the image processing system 140.

The functions of the imaging device 110 and the functions of the information terminal 120 described above are merely examples, and some of the functions of the imaging device 110 may be included in the information terminal 120. Alternatively, some of the functions of the information terminal 120 may be included in the imaging device 110.

In FIG. 1, the imaging device 110 and the information terminal 120 are configured as separate bodies. However, the imaging device 110 and the information terminal 120 may be configured as an integrated body. For example, the information terminal 120 may be a smartphone or a tablet having an imaging function. The imaging device 110 may have a communication function of communicating with the image processing system 140 via the communication network 130.

The image processing system 140 is a system that executes various processes for adjusting image characteristics of an image received via the communication network 130. An image processing program is installed in the image processing system 140, and the image processing program is executed, whereby the image processing system 140 functions as an image acquisition unit 150 and an image processing unit 160.

The image acquisition unit 150 receives an image from the information terminal 120 via the communication network 130, and stores the received image in the image storage unit 170. The image acquisition unit 150 transmits an adjusted image, which is obtained by executing various processes for adjusting the image characteristics on the image stored in the image storage unit 170, to the information terminal 120 via the communication network 130.

The image processing unit 160 reads the image stored in the image storage unit 170, executes various processes for adjusting image characteristics, and stores the adjusted image in the image storage unit 170.

With the image generation system 100, for example, even if a user of the imaging device 110 has captured an image in a scene where the imaging environment is dark, the user can transmit the image to the image processing system 140 via the information terminal 120 to acquire an image with high visibility.

With the image generation system 100, for example, the user of the imaging device 110 can acquire an image with high visibility even when the information terminal 120 does not include a high-performance processor.

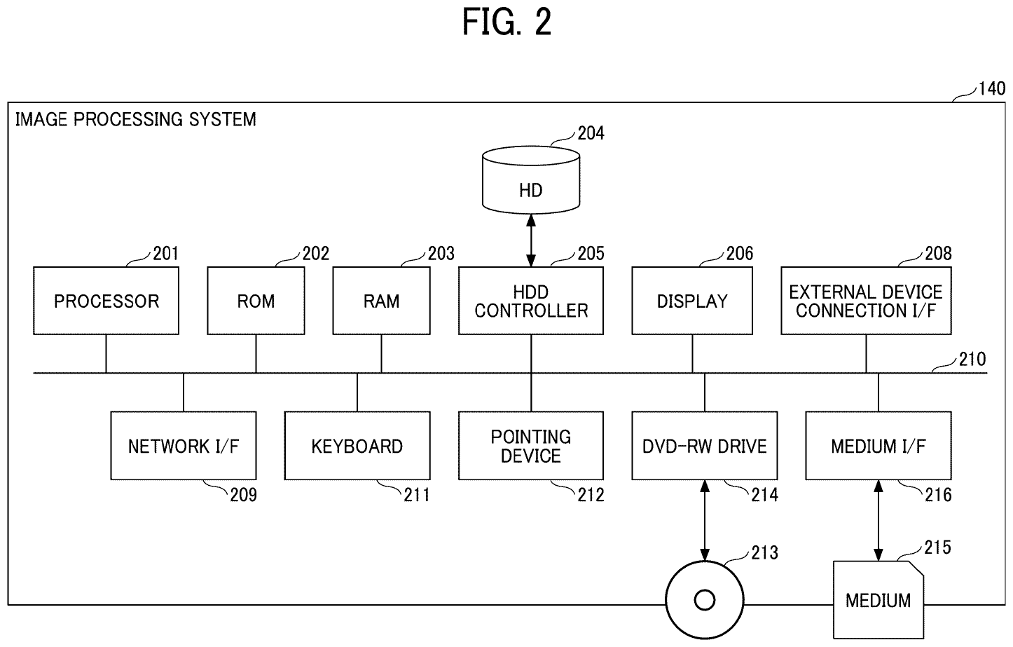

A description is given below of a hardware configuration of the image processing system 140. FIG. 2 is a diagram illustrating the hardware configuration of the image processing system 140. As illustrated in FIG. 2, the image processing system 140 is implemented by a computer. The image processing system 140 includes a processor 201, a read-only memory (ROM) 202, a random-access memory (RAM) 203, a hard disk (HD) 204, a hard disk drive (HDD) controller 205, a display 206, an external device connection interface (I/F) 208, a network I/F 209, a data bus 210, a keyboard 211, a pointing device 212, a digital versatile disk rewritable (DVD-RW) drive 214, and a medium I/F 216.

The processor 201 includes a central processing unit (CPU) and a graphics processing unit (GPU), and controls the overall operation of the image processing system 140. The ROM 202 stores a program such as an initial program loader (IPL) to boot the processor 201. The RAM 203 is used as a work area of the processor 201. The HD 204 stores various data such as a program. The HDD controller 205 controls reading and writing of various data from and to the HD 204 under control of the processor 201. The display 206 displays various information such as a cursor, a menu, a window, a character, or an image. The external device connection I/F 208 is an interface that connects the image processing system 140 to various external devices. In this case, the external devices include, but not limited to, a universal serial bus (USB) memory and a printer. The network I/F 209 is an interface that controls communication of data via the communication network 130. The data bus 210 is, for example, an address bus or a data bus, which electrically couples the components illustrated in FIG. 2, such as the processor 201.

The keyboard 211 serves as an input device, and provided with a plurality of keys that allow the user to input characters, numerals, or various instructions. The pointing device 212 also serves as an input device, and allows the user to select or execute a specific instruction, select a target for processing, or move a cursor being displayed. The DVD-RW drive 214 controls the reading or writing of various data from and to a DVD-RW 213, which is a removable storage medium. The removable storage medium is not limited to the DVD-RW and may be a digital versatile disc-recordable (DVD-R), for example. The medium I/F 216 controls reading or writing (storing) of data from or to a storage medium 215 such as a flash memory.

The hardware configuration of the image processing system 140 has been described above. The hardware configuration of the imaging device 110 and the hardware configuration of the information terminal 120 are also similar to, even if not the same as, the hardware configuration of the image processing system 140.

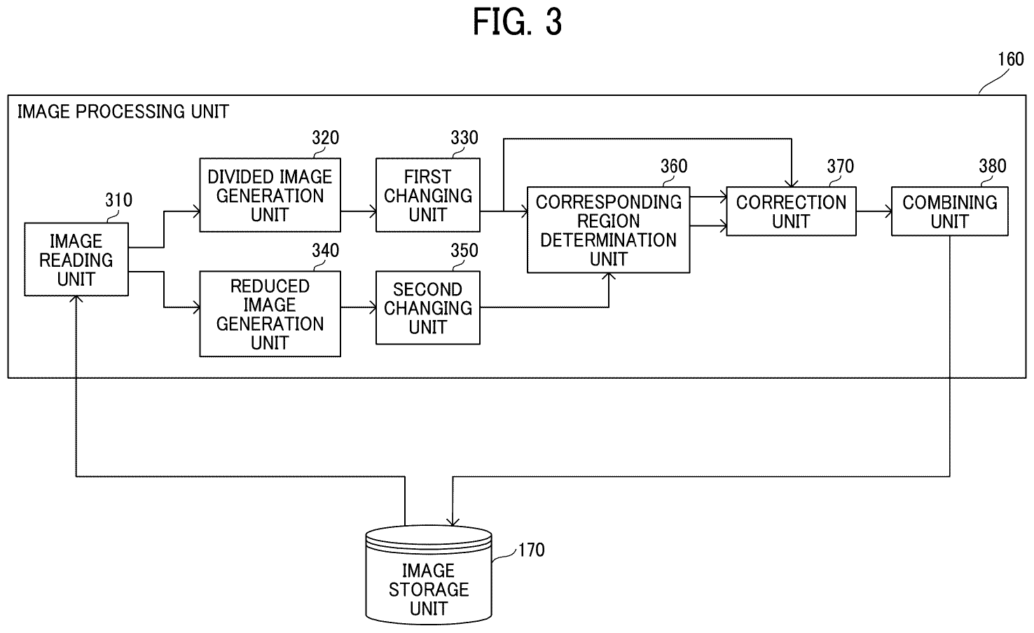

A description is given below of a functional configuration of the image processing unit 160. FIG. 3 is a diagram illustrating the functional configuration of the image processing unit 160.

As illustrated in FIG. 3, the image processing unit 160 includes an image reading unit 310, a divided image generation unit 320, a first changing unit 330, a reduced image generation unit 340, a second changing unit 350, a corresponding region determination unit 360, a correction unit 370, and a combining unit 380.

The image reading unit 310 reads the image stored in the image storage unit 170 by the image acquisition unit 150 from the image storage unit 170. The image reading unit 310 transmits the read image to the divided image generation unit 320 and the reduced image generation unit 340.

In the first embodiment, the image reading unit 310 transmits the read image as an image in the RGB format to the divided image generation unit 320 and the reduced image generation unit 340.

When the image stored in the image storage unit 170 is an image in the JPEG format, the image reading unit 310 includes a JPEG decoder that decodes an image in the JPEG format. When the image stored in the image storage unit 170 is an image in the YCbCr format, the image reading unit 310 includes a color space conversion unit that converts an image in the YCbCr format into an image in the RGB format.

The divided image generation unit 320 divides the image transmitted from the image reading unit 310 to generate a plurality of divided images. The divided image generation unit 320 divides the image into a size in which the pixel value of the image can be changed by the first changing unit 330 described later. The size of the pixel value that can be changed is determined by, for example, the capacity of the GPU memory included in the processor 201.

The first changing unit 330 changes the pixel values of at least some of the pixels included in the divided images transmitted from the divided image generation unit 320 to adjust the image characteristics (i.e., luminance and color difference) of each of the divided images. The first changing unit 330 includes any low light image enhancement (LLIE). The LLIE described above includes, for example, a learned model (AI model) that has been learned in advance so that the learned model adjusts the luminance or the color difference. The LLIE may include a learned model (AI model) that has been learned in advance so that the learned model improves noise or sharpness in addition to the luminance or the color difference. In this case, the divided image after adjustment by the LLIE is a divided image in which the noise or the sharpness is improved in addition to the luminance or the color difference. The LLIE may include, for example, a learned model (so-called generative AI) acquired by learning a large number of images.

The reduced image generation unit 340 reduces the image transmitted from the image reading unit 310 to generate a reduced image. In this disclosure, the reduction of the image means to apply processing to the image so that the processed image, which is the reduced image, has a smaller size and can be inscribed in a frame smaller than a frame of the image formed at a predetermined aspect ratio. The reduction of the image includes, for example, reducing the length of each side of a rectangular image without changing the aspect ratio. Alternatively, the reduction of the image includes, for example, reducing a rectangular image into a square image having a side shorter than a side of the rectangle of the original image. The “reduced image” refers to an image acquired by reducing the length in one or both of the vertical direction and the horizontal direction as compared with the image before reduction.

The reduced image generation unit 340 changes the original size of the image to a size in which the pixel value can be changed by the second changing unit 350 described later to generate a reduced image. The size of the image having the pixel value that can be changed is determined by, for example, the capacity of the GPU memory included in the processor 201.

The second changing unit 350 changes the pixel values of at least some of the pixels included in the reduced image transmitted from the reduced image generation unit 340 to adjust the image characteristics (i.e., luminance and color difference) of the reduced image. The second changing unit 350 includes any LLIE. The LLIE described above includes, for example, a learned model (AI model) that has been learned in advance so that the learned model adjusts the luminance or the color difference. The LLIE may include a learned model (AI model) that has been learned in advance so that the learned model improves noise or sharpness in addition to the luminance or the color difference. In this case, the divided image after adjustment by the LLIE is a divided image in which the noise or the sharpness is improved in addition to the luminance or the color difference. The LLIE may include, for example, a learned model (so-called generative AI) acquired by learning a large number of images. The LLIE included in the second changing unit 350 and the LLIE included in the first changing unit 330 may be the same LLIE or different LLIE (different LLIE having similar functions).

The corresponding region determination unit 360 determines a region corresponding to each of the divided images whose pixel values have been changed by the first changing unit 330, in the reduced image whose pixel values have been changed by the second changing unit 350.

The correction unit 370 acquires the divided images whose pixel values have been changed by the first changing unit 330. The correction unit 370 also acquires the reduced image whose pixel values have been changed by the second changing unit 350. The correction unit 370 corrects the pixel value of each of the divided images whose pixel values have been changed, using a correction value calculated based on the pixel value of each of the corresponding regions of the reduced image whose pixel values have been changed. As a result, the correction unit 370 can reduce the difference in image characteristics between the divided images for which the image characteristics have been separately optimized by the first changing unit 330.

The combining unit 380 combines the divided images after correction in which the difference in image characteristics is reduced by the correction unit 370 to generate an “adjusted image”. The combining unit 380 stores the adjusted image generated by the combining unit 380 in the image storage unit 170.

The combining unit 380 may include a JPEG encoder in the case of storing the adjusted image generated by the combining unit 380 in JPEG format.

A description is given below of processing of each unit included in the image processing unit 160 (i.e., the divided image generation unit 320, the first changing unit 330, the reduced image generation unit 340, the second changing unit 350, the corresponding region determination unit 360, and the correction unit 370).

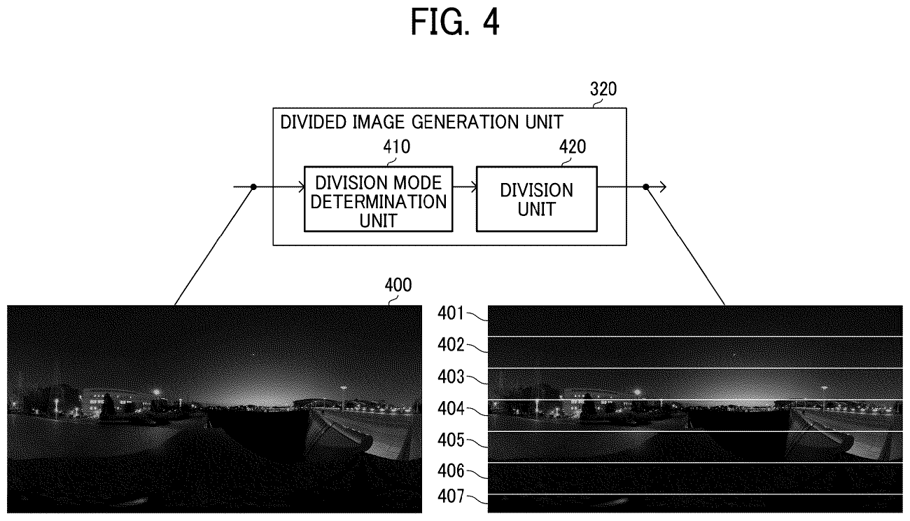

Firstly, a description is given below of processing executed by the divided image generation unit 320. FIG. 4 is a diagram illustrating processing executed by the divided image generation unit 320. As illustrated in FIG. 4, the divided image generation unit 320 includes a division mode determination unit 410 and a division unit 420.

The division mode determination unit 410 determines a division mode for dividing an image 400 transmitted from the image reading unit 310. The division mode includes a division direction, the number of divisions, and the number of pixels in the division direction of each divided image. The division direction indicates a direction whether to divide in the horizontal direction, the vertical direction, or both. The number of divisions indicates, for example, the number of divisions in which the number of pixels of each divided image is within the number of pixels of a size in which the pixel value can be changed. The number of pixels in the division direction of each divided image indicates whether to equalize the number of pixels according to the number of divisions or whether to set the number of pixels to a fixed number of pixels (e.g., a number of pixels close to the number of pixels of the maximum size in which the pixel value can be changed). The division mode determination unit 410 may determine the division mode based on, for example, an instruction from the user of the imaging device 110. Alternatively, the division mode determination unit 410 may determine the division mode based on a predetermined division mode. Alternatively, the division mode determination unit 410 may determine the division mode based on the number of pixels in the vertical direction and the number of pixels in the horizontal direction of the image 400 transmitted from the image reading unit 310, the type of the imaging device 110, or the capacity of the GPU memory included in the processor 201.

When the number of divisions is too large, the subsequent processing becomes complicated. For this reason, it is desirable that the number of divisions be as small as possible. When the division mode is determined, it is desirable to set a division mode in which noise is unlikely to occur in the subsequent processing.

The division unit 420 divides the image 400 in the division mode determined by the division mode determination unit 410. In FIG. 4, the image 400 is an image captured by the imaging device 110 which is an omnidirectional camera and is an image in which an angle of view of 360 degrees in the horizontal direction and an angle of view of 180 degrees in the vertical direction are uniformly recorded when the image capturing area is considered to be the surface of a sphere. The image 400 is an image with 2752 pixels in the vertical direction and 5504 pixels in the horizontal direction.

FIG. 4 illustrates a state in which the division mode determination unit 410 determines to divide the divided image in the vertical direction by the division line extending in the horizontal direction, and determines the fixed number of pixels (the number of pixels is close to 2.3 million pixels, which is the maximum size of pixels that can be changed) in the vertical direction of each divided image based on the number of pixels calculated based on the capacity of the GPU memory (2.3 million pixels in this case).

Specifically, the division mode determination unit 410 divides the capacity of the GPU memory (2.3 million pixels) by the number of pixels in the horizontal direction of the image 400 (5504 pixels) to calculate the number of pixels (417 pixels) and determines the number of pixels in the vertical direction of each divided image to be 400 pixels based on the calculated number of pixels (417 pixels).

In FIG. 4, divided images 401 to 407 indicate divided images acquired by the division unit 420 dividing the image 400 based on the division mode determined by the division mode determination unit 410.

In FIG. 4, the divided image 401 indicates a divided image in the range from the first pixel to the 400th pixel in the vertical direction of the image 400. The divided image 402 indicates a divided image in the range from the 401st pixel to the 800th pixel in the vertical direction of the image 400. The divided image 403 indicates a divided image in the range from the 801st pixel to the 1200th pixel in the vertical direction of the image 400. The divided image 404 indicates a divided image in the range from the 1201st pixel to the 1600th pixel in the vertical direction of the image 400. The divided image 405 indicates a divided image in the range from the 1601st pixel to the 2000th pixel in the vertical direction of the image 400. The divided image 406 indicates a divided image in the range from the 2001st pixel to the 2400th pixel in the vertical direction of the image 400. The divided image 407 indicates a divided image in the range from the 2401st pixel to the 2752nd pixel in the vertical direction of the image 400.

In FIG. 4, the number of pixels in the vertical direction of each divided image is fixed to 400 pixels, but the number of pixels in the vertical direction of each divided image may be equalized according to the number of divisions. For example, the division mode determination unit 410 may determine the number of divisions to be “7” so that the number of pixels of each divided image is equal to or less than the number of pixels (417 pixels) of the size that can be adjusted and may equally divide the image 400 so that the number of pixels of each divided image in the vertical direction is 393 pixels (2752 pixels divided by 7).

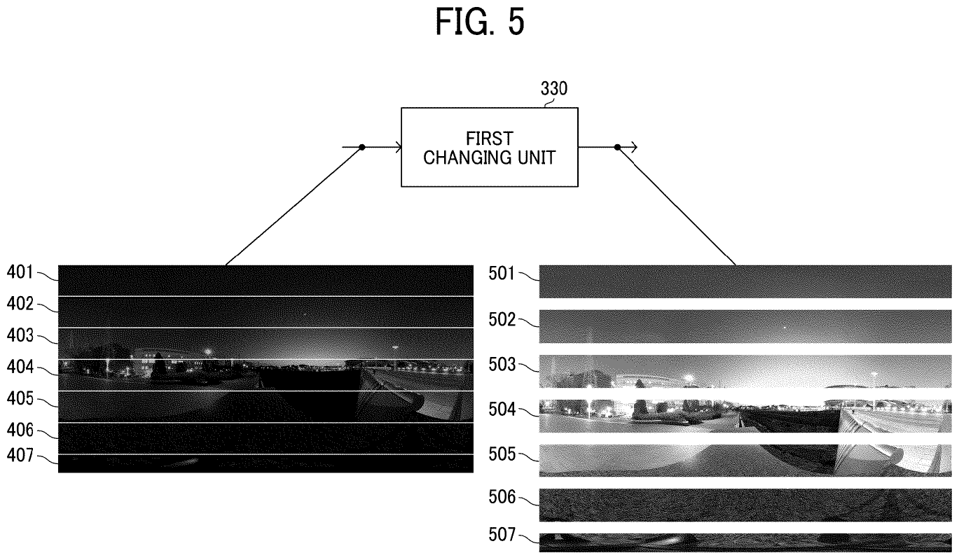

A description is given below of specific processing executed by the first changing unit 330. FIG. 5 is a diagram illustrating processing executed by the first changing unit 330.

The first changing unit 330 sequentially changes the pixel values of the divided images 401 to 407 transmitted from the divided image generation unit 320 to adjust the image characteristics of each of the divided images 401 to 407.

FIG. 5 illustrates a state in which the first changing unit 330 executes processing for increasing the luminance of the divided image 401 having a low luminance and outputs a divided image 501 having a high luminance. Similarly, FIG. 5 illustrates a state in which the first changing unit 330 executes processing for increasing the luminance of the divided image 402 having a low luminance and outputs a divided image 502 having a high luminance. Similarly, FIG. 5 illustrates a state in which the first changing unit 330 executes processing for increasing the luminance of the divided image 403 having a low luminance and outputs a divided image 503 having a high luminance. Similarly, FIG. 5 illustrates a state in which the first changing unit 330 executes processing for increasing the luminance of the divided image 404 having a low luminance and outputs a divided image 504 having a high luminance. Similarly, FIG. 5 illustrates a state in which the first changing unit 330 executes processing for increasing the luminance of the divided image 405 having a low luminance and outputs a divided image 505 having a high luminance. Similarly, FIG. 5 illustrates a state in which the first changing unit 330 executes processing for increasing the luminance of the divided image 406 having a low luminance and outputs a divided image 506 having a high luminance. Similarly, FIG. 5 illustrates a state in which the first changing unit 330 executes processing for increasing the luminance of the divided image 407 having a low luminance and outputs a divided image 507 having a high luminance.

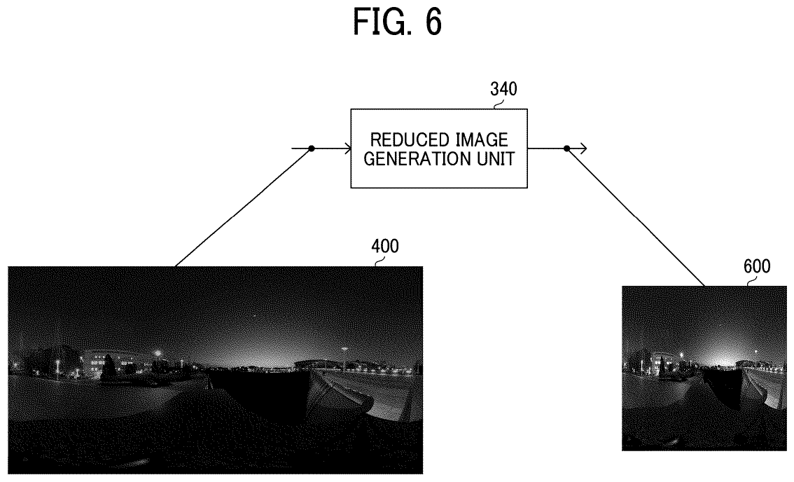

A description is given below of specific processing executed by the reduced image generation unit 340. FIG. 6 is a diagram illustrating processing executed by the reduced image generation unit 340.

FIG. 6 illustrates a state in which the reduced image generation unit 340 changes the size of the image 400 (2752 pixels in the vertical direction and 5504 pixels in the horizontal direction) transmitted from the image reading unit 310 to be smaller than the capacity of the GPU memory (2.3 million pixels) and generates a reduced image 600. In FIG. 6, the reduced image 600 is an image of 512 pixels in the vertical direction and 512 pixels in the horizontal direction.

The reduced image generated by the reduced image generation unit 340 does not need to maintain the aspect ratio of the image 400 transmitted from the image reading unit 310, and may have an aspect ratio different from that of the image 400.

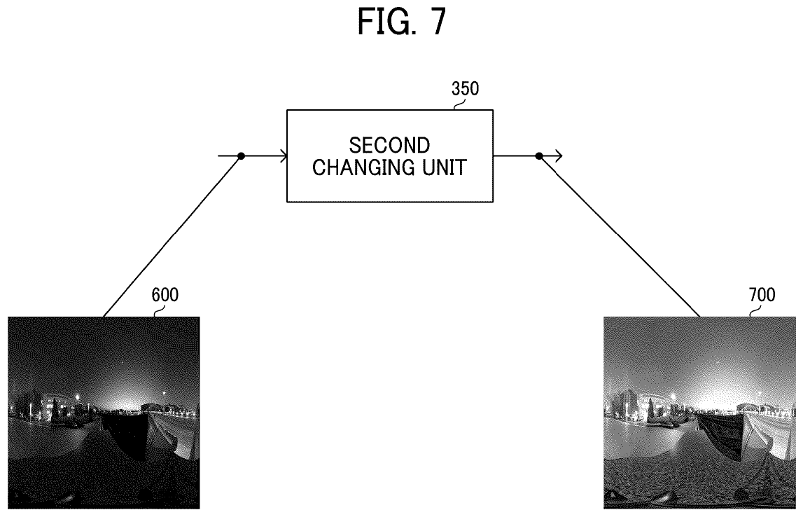

A description is given below of specific processing executed by the second changing unit 350. FIG. 7 is a diagram illustrating processing executed by the second changing unit 350.

The second changing unit 350 changes the pixel values of the reduced image 600 transmitted from the reduced image generation unit 340 to adjust the image characteristics of the reduced image 600.

FIG. 7 illustrates a state in which the second changing unit 350 executes processing for increasing the luminance of the reduced image 600 having a low luminance and outputs a reduced image 700 having a high luminance.

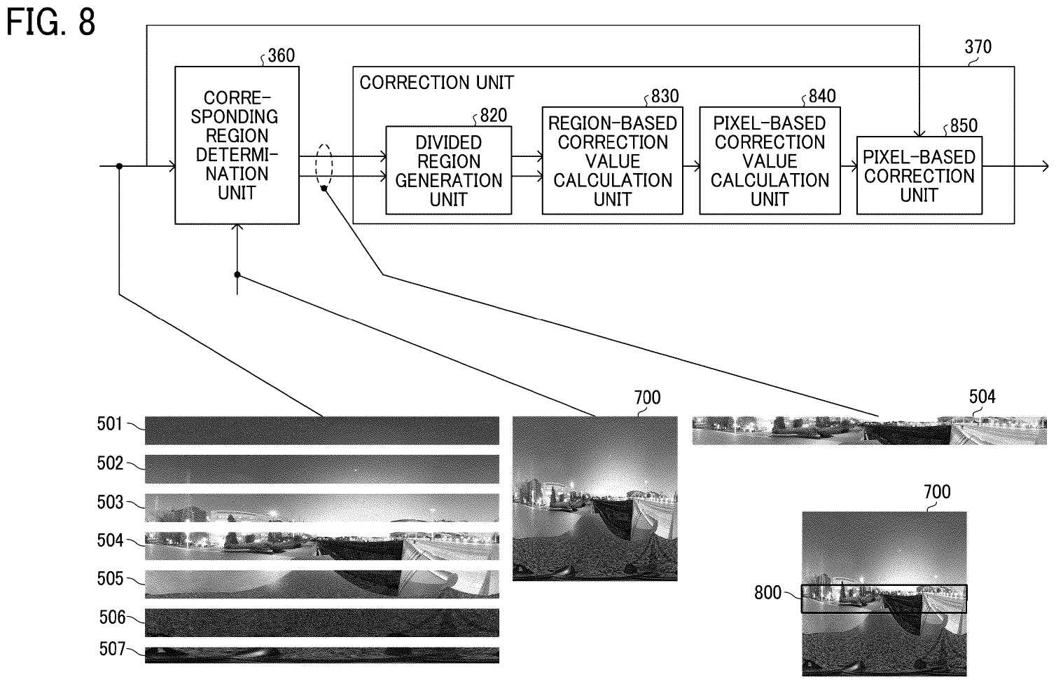

A description is given below of specific processing executed by the corresponding region determination unit 360 and the correction unit 370. FIGS. 8 to 11 are first to fourth diagrams illustrating specific processing executed by the corresponding region determination unit 360 and the correction unit 370. As illustrated in FIGS. 8 to 11, the correction unit 370 includes a divided region generation unit 820, a region-based correction value calculation unit 830, a pixel-based correction value calculation unit 840, and a pixel-based correction unit 850.

FIG. 8 illustrates specific processing executed by the corresponding region determination unit 360. The corresponding region determination unit 360 sequentially acquires the divided images 501 to 507 having high luminance from the first changing unit 330, and acquires the reduced image 700 having high luminance from the second changing unit 350.

The corresponding region determination unit 360 determines corresponding regions in the reduced image 700 having high luminance, which correspond to the divided images 501 to 507 having high luminance, respectively. Specifically, when the vertical start pixel of each of the divided images 501 to 507 with high luminance is ps, the vertical end pixel of each of the divided images 501 to 507 with high luminance is pe, the number of pixels of the image 400 in the vertical direction is Po, and the number of pixels of the reduced image 700 with high luminance in the vertical direction is Pr, then the start pixel ps' of the corresponding region can be expressed as “ps'=Pr×(ps/Po),” and the end pixel pe′ of the corresponding region can be expressed as “pe′=Pr×(pe/Po).”

FIG. 8 illustrates a state in which the corresponding region determination unit 360 determines a corresponding region in the reduced image 700 having high luminance, which corresponds to the divided image 504 having high luminance. As described above, in the case of the divided image 504 with high luminance, ps is the 1201st pixel, pe is the 1600th pixel, Po is the 2752nd pixel, and Pr is the 512nd pixel, and thus, the start pixel ps' of a corresponding region 800 is the 223rd pixel obtained by 512×(1201/2752), and the end pixel pe′ of the corresponding region 800 is the 298th pixel obtained by 512×(1600/2752).

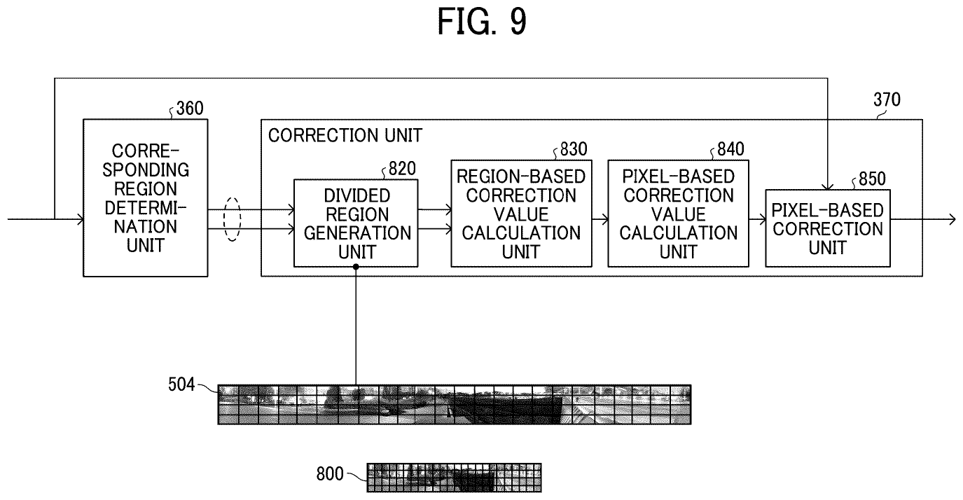

FIG. 9 illustrates processing executed by the divided region generation unit 820. The divided region generation unit 820 divides each of the divided images 501 to 507 having high luminance and each corresponding region in the reduced image 700 having high luminance into m in the vertical direction and n in the horizontal direction to generate m×n divided regions. The correspondence relation between each of the divided images 501 to 507 and each region in the reduced image 700 is determined by the corresponding region determination unit 360.

FIG. 9 illustrates a state in which the divided image 504 having high luminance is divided into four in the vertical direction and divided into 24 in the horizontal direction, and the corresponding region 800 is divided into four in the vertical direction and divided into 24 in the horizontal direction.

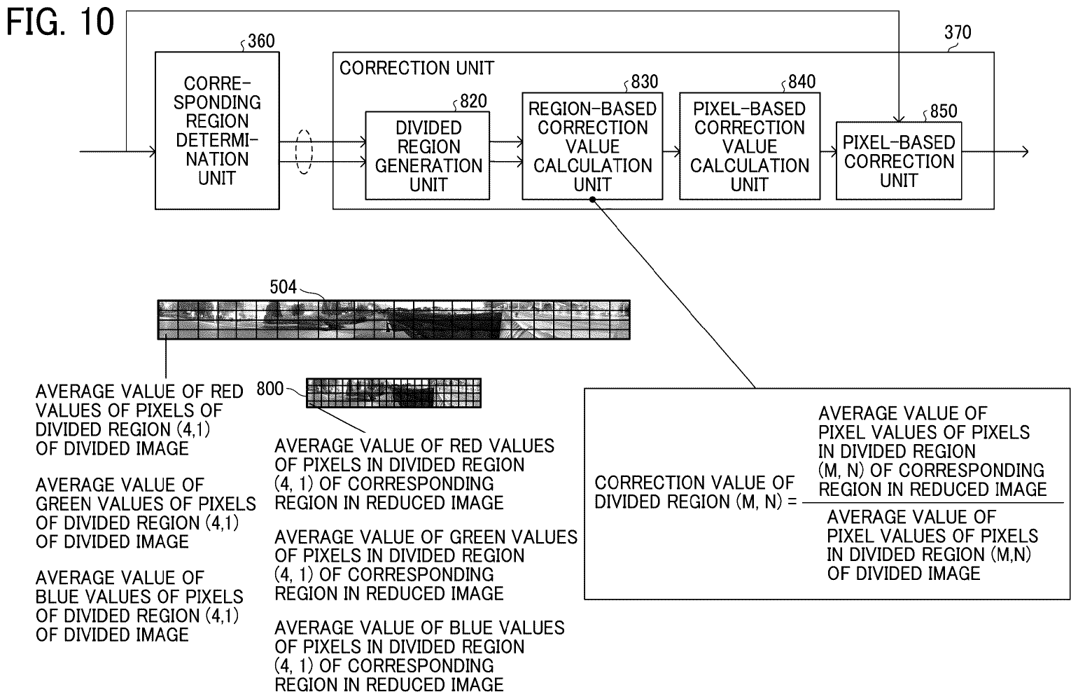

FIG. 10 illustrates processing executed by the region-based correction value calculation unit 830. The region-based correction value calculation unit 830 calculates a correction value for each divided region between m×n divided regions of each of the divided images 501 to 507 having high luminance and m×n divided regions of each corresponding region in the reduced image 700 having high luminance, which are generated by the divided region generation unit 820. Specifically, the region-based correction value calculation unit 830 calculates the correction value using the following formula. The correction value of the divided region (m, n)=(the average value of the pixel values of the pixels in the divided region (m, n) of the corresponding region in the reduced image (a second calculation value))/(the average value of the pixel values of the pixels in the divided region (m, n) of the divided image (a first calculation value)).

For example, the correction value of the red value of the divided region (4, 1) of the divided image 504 having high luminance is calculated by dividing the average value of the red values of the pixels included in the divided region (4, 1) of the corresponding region 800 in the reduced image 700 having high luminance by the average value of the red values of the pixels included in the divided region (4, 1) of the divided image 504 having high luminance.

Similarly, for example, the correction value of the green value of the divided region (4, 1) of the divided image 504 having high luminance is calculated by dividing the average value of the green values of the pixels included in the divided region (4, 1) of the corresponding region 800 in the reduced image 700 having high luminance by the average value of the green values of the pixels included in the divided region (4, 1) of the divided image 504 having high luminance.

Similarly, for example, the correction value of the blue value of the divided region (4, 1) of the divided image 504 having high luminance is calculated by dividing the average value of the blue values of the pixels included in the divided region (4, 1) of the corresponding region 800 in the reduced image 700 having high luminance by the average value of the blue values of the pixels included in the divided region (4, 1) of the divided image 504 having high luminance.

As described above, the region-based correction value calculation unit 830 calculates the correction value of the red value, the correction value of the green value, and the correction value of the blue value in the divided region unit.

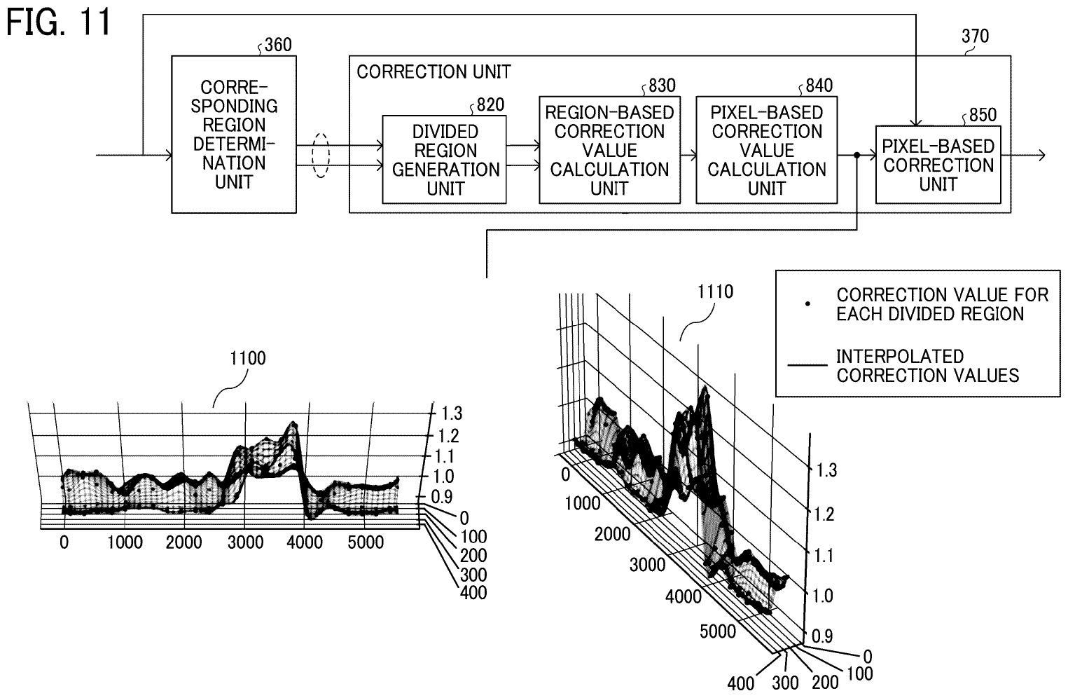

FIG. 11 illustrates processing executed by the pixel-based correction value calculation unit 840. The pixel-based correction value calculation unit 840 calculates the correction value of the red value, the correction value of the green value, and the correction value of the blue value in pixel units based on the correction value of the red value, the correction value of the green value, and the correction value of the blue value calculated in divided region units by the region-based correction value calculation unit 830.

Specifically, the pixel-based correction value calculation unit 840 sets the correction value of the red value calculated in the divided region unit by the region-based correction value calculation unit 830 as the representative value of each divided region and interpolates the correction value of the red value of each pixel between the representative values. Similarly, the pixel-based correction value calculation unit 840 sets the correction value of the green value calculated in the divided region unit by the region-based correction value calculation unit 830 as the representative value of each divided region and interpolates the correction value of the green value of each pixel between the representative values. Similarly, the pixel-based correction value calculation unit 840 sets the correction value of the blue value calculated in the divided region unit by the region-based correction value calculation unit 830 as the representative value of each divided region and interpolates the correction value of the blue value of each pixel between the representative values.

Any method of interpolating the correction value by the pixel-based correction value calculation unit 840 can be employed. For example, the interpolation may be performed by linear interpolation or may be performed using a bicubic interpolation. When the bicubic interpolation is employed, interpolation can be performed so that the correction value changes more smoothly. In FIG. 10, the first calculation value is the average value of the red values, the average value of the green values, and the average value of the blue values of the pixels in the divided region (m, n) of the divided image. However, the first calculation value may be an average value of any of the luminance signal (Y value) and the color difference signals (Cb value, Cr value) acquired by converting the red value, the green value, and the blue value of each pixel into the YCbCr format. Similarly, in FIG. 10, the second calculation value is the average value of the red values, the average value of the green values, and the average value of the blue values of the pixels in the divided region (m, n) of the corresponding region in the reduced image. However, the second calculation value may be an average value of any of the luminance signal (Y value) and the color difference signals (Cb value, Cr value) acquired by converting the red value, the green value, and the blue value of each pixel into the YCbCr format.

In FIG. 11, graphs 1100 and 1110 illustrate the interpolation of the correction value of the red value corrected by the pixel-based correction value calculation unit 840. Black circles in the graphs 1100 and 1110 indicate the correction values of the red values calculated in the divided region unit, and intersections of the meshes indicate the correction values of the red values of each of the pixels. In the graphs 1100 and 1110, the mesh has been coarsened for the convenience of the space limitations, and only some pixel correction values are illustrated.

As described above, the correction unit 370 firstly calculates the correction value in the region unit, and then interpolates to calculate the correction value in pixel units. When the correction value is calculated based on the pixel value of the reduced image and the correction value is calculated in pixel units from the beginning, the reduced image has a lower resolution than the divided image. Thus, when the correction is performed using the calculated correction value, the divided image after the correction is a blurred image. In contrast, since the low resolution of the reduced image can be covered by interpolation, the above-described method can avoid each divided image from being a blurred image.

The correction value of the red value, the correction value of the green value, and the correction value of the blue value in pixel units for each of the divided images calculated by the pixel-based correction value calculation unit 840 are notified to the pixel-based correction unit 850. As a result, the pixel-based correction unit 850 can correct each of the divided images having high luminance in pixel units to generate “divided images after correction.”

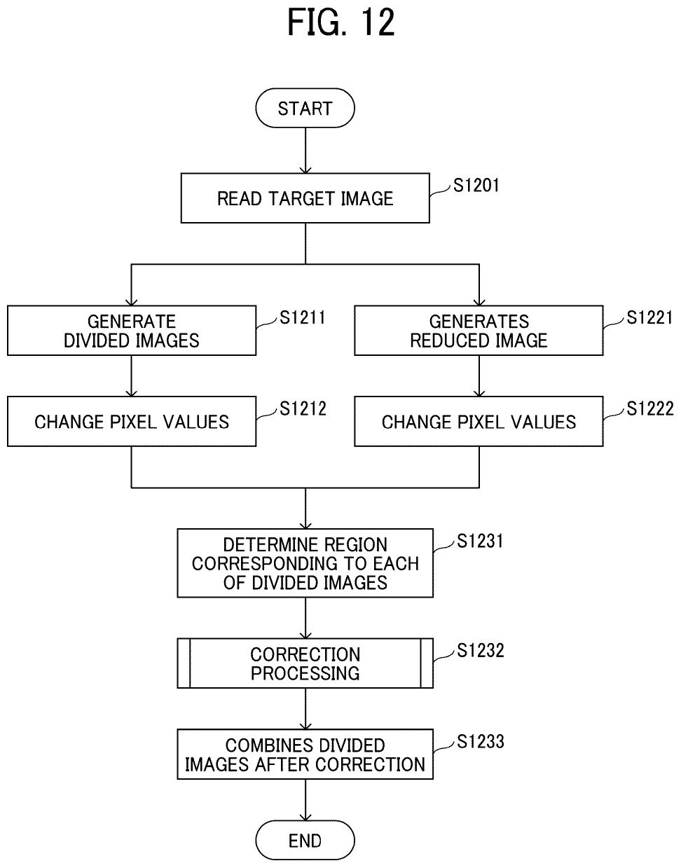

A description is given below of image processing executed by the image processing system 140. FIG. 12 is a flowchart of the image processing executed by the image processing system 140.

In step S1201, the image reading unit 310 reads a target image from the image storage unit 170.

In step S1211, the divided image generation unit 320 divides the read image to generate a plurality of divided images.

In step S1212, the first changing unit 330 changes the pixel values for each of the generated divided images to adjust the image characteristics.

In step S1221, the reduced image generation unit 340 changes the size of the target image read in step S1201 and generates a reduced image.

In step S1222, the second changing unit 350 changes the pixel values of the reduced image generated in step S1221 to adjust the image characteristics.

In step S1231, the corresponding region determination unit 360 determines a region corresponding to each of the divided images whose pixel values have been changed in the reduced image whose pixel values have been changed.

In step S1232, the correction unit 370 corrects the pixel values of the divided images whose pixel values have been changed, using correction values calculated based on the pixel values of the corresponding regions of the reduced image whose pixel values have been changed. The correction processing (step S1232) is described in detail later.

In step S1233, the combining unit 380 combines the “divided images after correction” to generate an “adjusted image.”

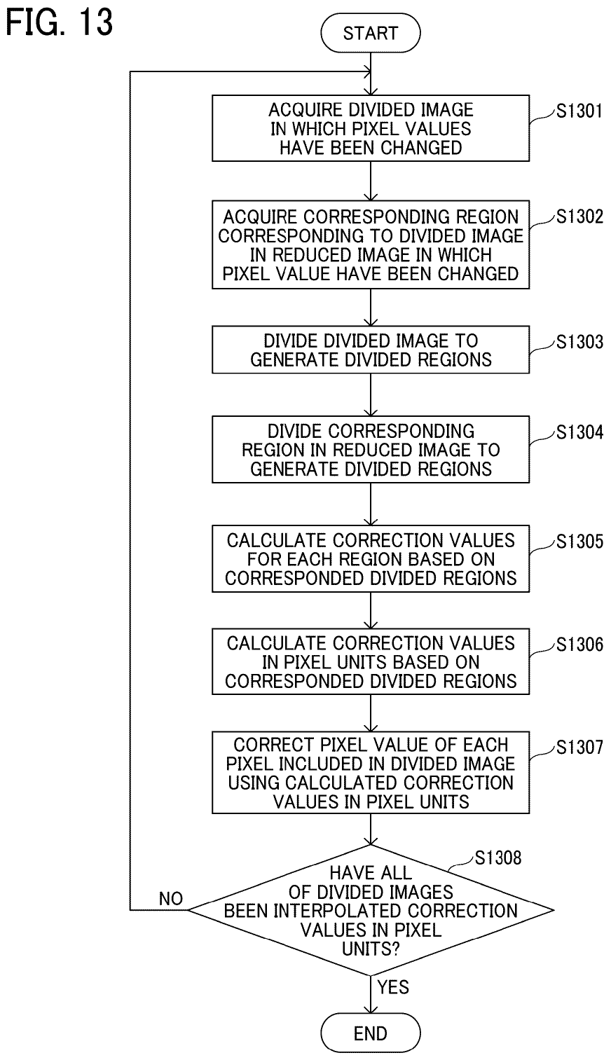

A description is given below of the correction processing (step S1232 in FIG. 12) executed by the image processing system 140. FIG. 13 is a flowchart of the correction processing executed by the image processing system 140.

In step S1301, the correction unit 370 acquires one divided image from among the divided images whose pixel values have been changed.

In step S1302, the correction unit 370 acquires a corresponding region corresponding to the one divided image acquired in step S1301 in the reduced image whose pixel values have been changed.

In step S1303, the correction unit 370 divides the one divided image acquired in step S1301 to generate a plurality of divided regions.

In step S1304, the correction unit 370 divides the corresponding region in the reduced image acquired in step S1302 to generate a plurality of divided regions.

In step S1305, the correction unit 370 calculates correction values for each region based on the divided regions generated in step S1303 and the divided regions generated in step S1304.

In step S1306, the correction unit 370 interpolates the correction values calculated in step S1305 for each region to calculate the correction values in pixel units.

In step S1307, the correction unit 370 corrects the pixel value of each pixel included in the one divided image acquired in step S1301 using the calculated correction values in pixel units.

In step S1308, the correction unit 370 determines whether the processes in steps S1301 to S1307 has been executed for each of the divided images for which the image characteristics have been adjusted by changing the pixel values. When the correction unit 370 determines in step S1308 that there is a divided image for which the processes in steps S1301 to S1307 has not been executed (NO in step S1308), the process returns to step S1301.

On the other hand, in step S1308, when the correction unit 370 determines that the processes in steps S1301 to S1307 has been executed for all the divided images (YES in step S1308), the correction processing is ended, and the process returns to step S1233 of FIG. 12.

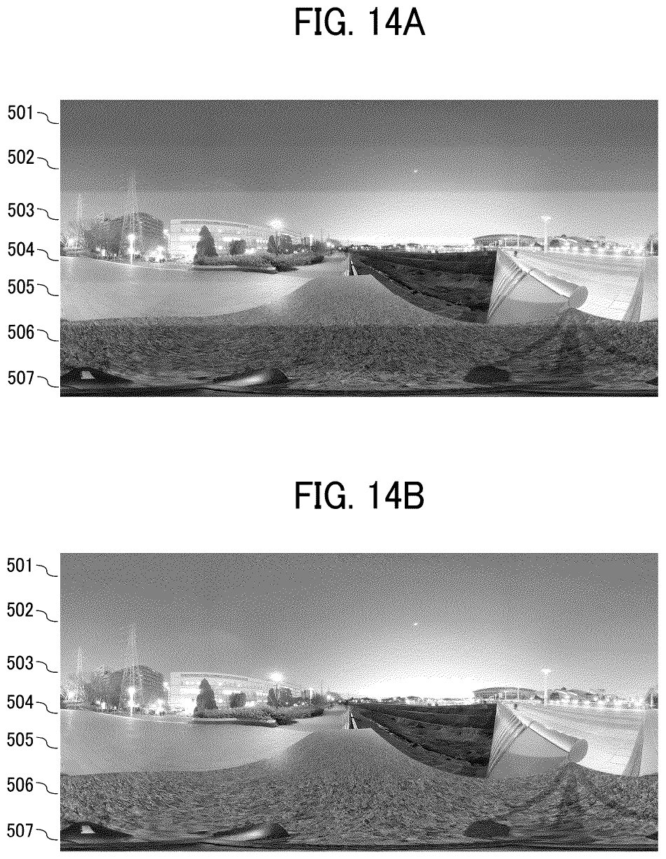

A description is given below of an image on which image processing has been executed by the image processing system 140. FIGS. 14A and 14B are diagrams illustrating images on which image processing has been executed by the image processing system 140.

FIG. 14A illustrates an image on which the image processing system 140 has executed image processing without executing the correction processing (step S1232) as a comparative example. As illustrated in FIG. 14A, when the image processing system 140 executes the image processing without executing the correction processing (step S1232), a difference in brightness occurs between the divided images 501 and 502 and the divided images 503 to 505, among the divided images 501 to 507 adjusted to have high brightness.

Accordingly, a pattern in the horizontal direction is visually recognized between the divided images 501 and 502 and the divided images 503 to 505. Similarly, when the image processing system 140 executes the image processing without executing the correction processing (step S1232), a difference in brightness occurs between the divided images 503 to 505 and the divided images 506 and 507, among the divided images 501 to 507 whose pixel values are changed to have high brightness. Accordingly, a pattern in the horizontal direction is visually recognized between the divided images 503 to 505 and the divided images 506 and 507.

On the other hand, FIG. 14B illustrates an image in a case where the correction processing (step S1232) is executed in the image processing by the image processing system 140. As illustrated in FIG. 14B, when the correction processing (step S1232) is executed, no difference in brightness occurs between the divided images after the image processing. Thus, no pattern in the horizontal direction is visually recognized.

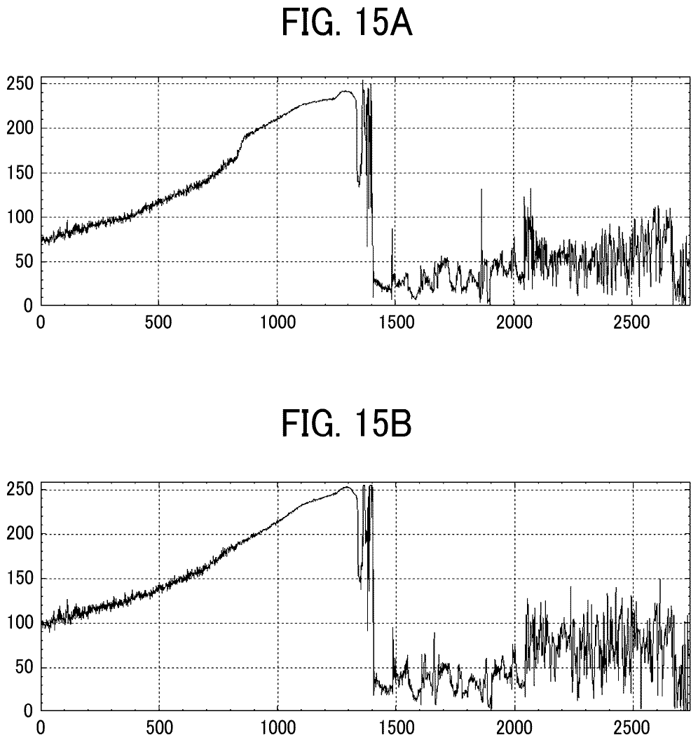

FIGS. 15A and 15B are diagrams illustrating examples of the luminance of pixels included in an image on which image processing has been executed by the image processing system 140. FIGS. 15A and 15B illustrate changes in luminance of pixels in the vertical direction at a predetermined position in the horizontal direction (3700th pixel in FIGS. 15A and 15B) of the images illustrated in FIGS. 14A and 14B, respectively. In other words, the horizontal axis of FIGS. 15A and 15B represents the number of pixels in the vertical direction of the image after the image processing, and the vertical axis represents the luminance of each pixel of the image after the image processing.

When FIG. 15A and FIG. 15B are compared, for example, a difference in luminance occurs around the 800th pixel in the vertical direction in FIG. 15A, whereas the difference in luminance disappears in FIG. 15B. This corresponds to the fact that the horizontal pattern visually recognized between the divided images 501 and 502 and the divided images 503 to 505 in FIG. 14A is not visually recognized in FIG. 14B.

When FIG. 15A and FIG. 15B are compared, for example, the luminance of the 1400th and subsequent pixels in the vertical direction is low in FIG. 15A, whereas the luminance of the 1400th and subsequent pixels in the vertical direction is high in FIG. 15B. This corresponds to the fact that the horizontal pattern visually recognized between the divided images 503 to 505 and the divided images 506 and 507 in FIG. 14A is not visually recognized in FIG. 14B.

As described above, the image processing system 140 can reduce the difference in image characteristics between the divided images which occurs when various processing for adjusting image characteristics are executed.

As described above, the image processing system 140 according to the first embodiment divides an image and generates a plurality of divided images. The image processing system 140 according to the first embodiment changes the pixel values of each of the divided images. The image processing system 140 according to the first embodiment reduces the image to generate a reduced image of the image. The image processing system 140 according to the first embodiment changes the pixel values of the reduced image. The image processing system 140 according to the first embodiment determines a region corresponding to each of the divided images whose pixel values have been changed in the reduced image whose pixel values have been changed. The image processing system 140 according to the first embodiment corrects the pixel value of the divided image whose pixel value has been changed based on the pixel value of a pixel included in the determined region. The image processing system 140 according to the first embodiment combines the corrected divided images.

As a result, the image processing system 140 according to the first embodiment can reduce the difference in image characteristics between the divided images whose pixel values have been changed.

### Second Embodiment

In the first embodiment described above, the case where the divided image generation unit 320 divides an image so that the divided images do not overlap each other when dividing the image and generating the divided images has been described. However, the method of dividing the image performed by the divided image generation unit 320 is not limited to this. For example, the divided image generation unit 320 may divide the image so that the divided images after the division overlap each other.

In this case, when the pixel-based correction unit 850 corrects the pixel values of each of the divided images using the correction values in pixel units calculated for each of the divided images, the pixel-based correction unit 850 uses a correction value acquired by weighting and adding the correction values calculated for the divided images for the overlapping portion. Any weighting method can be used when performing weighting and adding the correction values, and weighting may be performed with a fixed value (e.g., 0.5) regardless of the overlapping position, or weighting may be performed with a different value in accordance with the overlapping position.

### Third Embodiment

In the first embodiment described above, the image processing system 140 executes image processing in response to an instruction from the information terminal 120. However, when the image processing system 140 receives the instruction from the information terminal 120, the image processing system 140 may be configured to perform image processing after charging the user of the imaging device 110. In other words, the image processing system 140 may be a system that provides an image processing service on a cloud on condition that the user is charged.

When the image processing system 140 provides the image processing service, the image processing system 140 may also provide a dedicated application used by the user who receives the image processing service. The dedicated application may include a user interface for designating an image to be processed, designating a processing purpose, designating a representation format of a processed image, and designating a compression format of a processed image.

### Fourth Embodiment

In the first embodiment described above, the image reading unit 310 transmits the read image as an image in the RGB format to the divided image generation unit 320 and the reduced image generation unit 340. According to the first embodiment, when the luminance is adjusted as the image characteristic, the color difference is also adjusted.

In contrast, when the read image is transmitted to the divided image generation unit 320 and the reduced image generation unit 340 as an image in the YCbCr format, the luminance or the color difference can be adjusted separately as the image characteristic.

In other words, the image processing system 140 may be configured to select the format of the image according to the processing purpose of the user.

### Other Embodiment

In the first embodiment described above, the image processing unit 160 is implemented in the image processing system 140. However, some or each of functional units included in the image processing unit 160 may be implemented by an image processing system, an image processing apparatus, or an image processing terminal other than the image processing system 140.

In the first embodiment described above, only the image processing system 140 executes the image processing program. However, the image processing system 140 may be implemented, for example, by a plurality of computers and the image processing program may be installed in each computer and executed in a distributed computing environment.

Aspects of the present disclosure are, for example, as follows.

### Aspect 1

An image processing system includes a divided image generation unit, a first changing unit, a reduced image generation unit, a second changing unit, a corresponding region determination unit, a correction unit, and a combining unit. The divided image generation unit divides an image to generate a plurality of divided images. The first changing unit changes a pixel value of each of the plurality of divided images. The reduced image generation unit reduces the image to generate a reduced image of the image. The second changing unit changes a pixel value of the reduced image. The corresponding region determination unit determines a region corresponding to each of a plurality of divided images changed by the first changing unit in the reduced image changed by the second changing unit. The correction unit corrects the pixel value of the divided image changed by the first changing unit based on a pixel value of a pixel included in the determined region. The combining unit combines a plurality of divided images corrected by the correction unit.

### Aspect 2

In the image processing system according to Aspect 1, the pixel value includes information on luminance and color difference. The first changing unit changes the pixel values of the divided image so that one or both of luminance and color difference of at least some of pixels of the divided image is increased. The second changing unit changes the pixel value of the reduced image so that one or both of luminance and color difference of at least some of pixels of the reduced image is increased.

### Aspect 3

In the image processing system according to Aspect 1, the correction unit calculates a correction value for each of a plurality of divided regions based on a first calculation value calculated from pixel values of pixels included in divided regions acquired by further dividing the divided image whose pixel value has been changed and a second calculation value calculated from pixel values of pixels included in a region acquired by dividing a region corresponding to the divided image in the reduced image whose pixel value has been changed.

### Aspect 4

In the image processing system according to Aspect 3, the first calculation value is an average value of pixel values of pixels included in the divided region. The second calculation value is an average value of pixel values of pixels included in a region acquired by dividing a region corresponding to the divided image in the reduced image.

### Aspect 5

In the image processing system according to Aspect 3, the correction unit uses the correction value of each of the plurality of divided regions to interpolate a correction value for correcting a pixel value of each pixel included in each of the plurality of divided regions. The correction unit uses the interpolated correction value of each pixel to correct the pixel value of each pixel included in each of the plurality of divided areas changed by the first changing unit.

### Aspect 6

In the image processing system according to any one of Aspects 1 to 5, the plurality of divided images include a portion in which adjacent divided images overlap each other. The correction unit performs correction using a correction value acquired by weighting and adding the correction values of the pixels calculated for the divided images for the overlapped portion of the adjacent divided images.

### Aspect 7

An image processing apparatus includes a divided image generation unit, a first changing unit, a reduced image generation unit, a second changing unit, a corresponding region determination unit, a correction unit, and a combining unit. The divided image generation unit divides an image to generate a plurality of divided images. The first changing unit changes a pixel value of each of the plurality of divided images. The reduced image generation unit reduces the image to generate a reduced image of the image. The second changing unit changes a pixel value of the reduced image. The corresponding region determination unit determines a region corresponding to each of a plurality of divided images changed by the first changing unit in the reduced image changed by the second changing unit. The correction unit corrects the pixel value of the divided image changed by the first changing unit based on a pixel value of a pixel included in the determined region. The combining unit combines a plurality of divided images corrected by the correction unit.

### Aspect 8

A method causes a computer to perform a method for image processing. The method includes: dividing an image to generate a plurality of divided images; changing a pixel value of each of the plurality of divided images; reducing the image to generate a reduced image of the image; changing a pixel value of the reduced image; determining a region corresponding to each of a plurality of divided images changed by the first changing unit in the reduced image changed by the second changing unit; correcting the pixel value of the divided image changed by the first changing unit based on a pixel value of a pixel included in the determined region; and combining a plurality of divided images corrected by the correction unit.

### Aspect 9

A program causes a computer to perform a method for image processing. The method includes: dividing an image to generate a plurality of divided images; changing a pixel value of each of the plurality of divided images; reducing the image to generate a reduced image of the image; changing a pixel value of the reduced image; determining a region corresponding to each of a plurality of divided images changed by the first changing unit in the reduced image changed by the second changing unit; correcting the pixel value of the divided image changed by the first changing unit based on a pixel value of a pixel included in the determined region; and combining a plurality of divided images corrected by the correction unit.

The configurations according to the above-described embodiments of the present disclosure may be combined with other components, and the embodiments of the present disclosure are not limited to the above-described configurations. The elements of the above-described embodiments can be modified without departing from the gist of the present disclosure and can be appropriately determined according to the application form.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processing system comprising:
processing circuitry configured to:
divide an image to generate a plurality of divided images;
change pixel values of each of the plurality of divided images;
reduce the image to generate a reduced image of the image;
change pixel values of the reduced image;
determine a plurality of regions of the reduced image, each region corresponding to each of the plurality of divided images having the changed pixel values;
correct the changed pixel values of the divided image based on pixel values of one or more pixels included in the determined region of the reduced image; and
combine a plurality of divided images each having the corrected pixel values.

2. The image processing system according to claim 1,
wherein the pixel value includes information on luminance and color difference, and
wherein the processing circuitry is configured to:
change the pixel values of the divided image so that one or both of luminance and color difference of one or more pixels are increased; and
change the pixel values of the reduced image so that one or both of luminance and color difference of one or more pixels are increased.

3. The image processing system according to claim 1,
wherein the processing circuitry is configured to:
calculate a first calculation value from pixel values of pixels included in a plurality of divided regions acquired by further dividing at least one of the divided images having the changed pixel values;
calculate a second calculation value from pixel values of pixels included in a region acquired by further dividing the region of the reduced image having the changed pixel values, which corresponds to the divided image; and
calculate a correction value for each of the plurality of divided regions based on the first calculation value and the second calculation value.

4. The image processing system according to claim 3,
wherein the first calculation value is an average value of the pixel values of the pixels included in the divided region, and
the second calculation value is an average value of the pixel values of the pixels included in the region acquired by further dividing the region of the reduced image that corresponds to the divided image.

5. The image processing system according to claim 3,
wherein the processing circuitry is configured to:
use the correction value of each of the plurality of divided regions to interpolate the correction value for correcting the pixel value of each pixel included in each of the plurality of divided regions; and
use the interpolated correction value of each pixel to correct the pixel value of each pixel included in each of the plurality of divided regions having the changed pixel values.

6. The image processing system according to claim 1,
wherein the plurality of divided images include a portion in which adjacent divided images overlap each other, and
wherein the processing circuitry is configured to perform correction using a correction value acquired by weighting and adding the correction values of the pixels calculated for the divided images for the overlapped portion of the adjacent divided images.

7. An image processing method, executed by a computer, the method comprising:
dividing an image to generate a plurality of divided images;
changing pixel values of each of the plurality of divided images;
reducing the image to generate a reduced image of the image;
changing pixel values of the reduced image;
determining a plurality of regions of the reduced image, each region corresponding to each of the plurality of divided images having the changed pixel values;
correcting the changed pixel values of the divided image based on pixel values of one or more pixels included in the determined region of the reduced image; and
combining a plurality of divided images each having the corrected pixel values.

8. A non-transitory storage medium storing computer-readable program code that, when executed by a computer, causes the computer to perform an image processing method, the method comprising:
dividing an image to generate a plurality of divided images;
changing pixel values of each of the plurality of divided images;
reducing the image to generate a reduced image of the image;
changing pixel values of the reduced image;
determining a plurality of regions of the reduced image, each region corresponding to each of the plurality of divided images having the changed pixel values;
correcting the changed pixel values of the divided image based on pixel values of one or more pixels included in the determined region of the reduced image; and
combining a plurality of divided images each having the corrected pixel values.
